(19) United States
(12) Patent Application Publication
(10) Pub. No.: US 2002/0086121 A1
(43) Pub. Date: Jul. 4, 2002

(54) Moisture-resistant, shape-retaining fabric, ribbon and bow and process for manufacturing same

(76) Inventors: Arnold M. Shulman, Hillsdale, NJ (US); Seth E. Shulman, Hackensack, NJ (US)

Correspondence Address: WEINGRAM & ASSOCIATES, P.C., 197 W. Spring Valley Avenue, P.O. BOX 927, Maywood, NJ, 07607, US

(21) Appl. No.: 10/004,268

(22) Filed: Nov. 2, 2001

Related U.S. Application Data
(60) Provisional application No. 60/245,510, filed on Nov. 3, 2000.

(51) Int. Cl. B32B 31/00; D04D 7/06; B32B 5/02; B32B 9/00

(52) U.S. Cl. 428/4; 442/394; 442/103; 156/253

(57) ABSTRACT

A method of making moisture-resistant, shape-retaining fabric, comprising the steps of contacting at least one surface of said fabric with a polymeric material and curing said polymeric material so that the polymeric material penetrates the interstices of the fabric and forms a permanent coating on at least one surface of the fabric. The polymeric material is selected from the group consisting of polyvinyl chloride, urethane, or a polyvinyl chloride-urethane blend in proportions ranging from 5% to 95% polyvinyl chloride to 95% to 5% urethane. The fabric may be cut to form ribbons and may be assembled to form bows. The fabric, ribbons or bows of the invention retain their original shape, drape and form despite exposure to water, moisture, refrigeration or the elements.

### BACKGROUND

1. Field of the Invention

This invention relates to decorative, weather-resistant, shape-retaining fabric and a method for forming such fabric. In another aspect, this invention relates to an improved moisture-resistant, shape-retaining ribbon and method for forming such ribbons into bows. In yet another aspect, this invention relates to a ribbon and method for forming said ribbon which is exceptionally shape-retaining and water-resistant in outdoor installations. The invention finds use in the gift, basket, food and floral industries where fabric, ribbons, and bows are included in crafts, baskets, works of art, wreaths or floral arrangements, food and other packaging intended for indoor and outdoor use or display.

2. Description of the Prior Art

Fabric, ribbons and bows are used in sundry applications for ornamental or decorative purposes, including in baskets, crafts, wreaths and flower arrangements, hair accessories, and for gift-wrapping and packaging for food and sundry items, for both indoor and outdoor use. Printed and non-printed (or solid-colored) fabric, ribbons and bows used for such purposes are, at times, exposed to variations in temperature and moisture. Specifically, printed and non-printed ribbons, and bows used in such applications as refrigerated flower arrangements, outdoor wreaths, baskets, crafts, balloons, flags and table decorations, and other outdoor artistic arrangements and decorations, which are exhibited, hung, or displayed outdoors, are exposed to the elements. However, the printed and non-printed fabric, ribbons, and bows used in these applications are not waterproof or even water-resistant. By “waterproof” is meant impermeable to moisture. By “water-resistant”, “moisture-resistant”, or “weather-resistant” is meant the ability of the fabric, ribbon, or bow to resist the deleterious effects of water, moisture, or the elements, i.e, the fabric, ribbon or bow which is exhibited, hung, or displayed retains its original shape or form despite exposure to water, moisture or the elements. Upon exposure to moisture or refrigeration, fabric, ribbons and bows presently used in the arts and crafts, gift, and floral industries wilt, droop, or otherwise become limp or lose their shape. This detracts from the aesthetic appearance of the floral arrangement or other art form in which the fabric, ribbon or bow is displayed or employed.

Fabric, ribbons and bows currently used in baskets, crafts, wreaths or floral arrangements, on food, packaging, and other applications intended for outdoor use or display are typically untreated. Therefore, not all fabrics may be used in outdoor applications. For instance, cotton ribbon or bows are unsuitable as they immediately lose their shape and drape when contacted with moisture.

Currently, the reverse, peripheral edges of some fabrics, ribbons or bows are optionally coated with an acrylic finish or other firm, non-fray finishes. This acrylic finish or other firm, nonfray finish seals the edges to prevent unraveling, so it is non-fraying, and stiffens the fabric or ribbon slightly so it is easier to slit or cut. The problem with an acrylic finish or these other finishes is that it is water-soluble and washes out when moistened. Ribbons and bows made of uncoated or acrylic-finished fabric are unsuitable for outdoor use, as exposure to rain, snow, sleet or other forms of moisture will cause said fabric, and ribbons and bows made therefrom, to droop, become limp, and lose their shape. There is therefore a need for improved printed or solid-colored fabric, ribbons, and bows which can maintain their shape and drape and be weather-resistant and moisture-resistant over long periods of use and exposure to the elements or refrigeration. Such fabric, ribbons, and bows may be pre-tied or arranged in advance, for use with flowers or food, for example, and then refrigerated or frozen, without adverse consequences.

### OBJECTS AND SUMMARY OF THE INVENTION

Accordingly, it is an object of the invention to provide improved fabric, ribbons, and bows and a method of forming weather-resistant and moisture-resistant fabric, ribbons, and bows which are shape-retaining upon exposure to the elements.

It is a further object of the invention to provide improved fabric, ribbons and bows that will resist the ravages of rain, sleet, snow, sunlight, extremes of temperature, and the like.

Yet another object of the invention is to provide water-resistant, re-usable, shape-retaining and long-lasting decorative fabric, ribbons and bows for use indoors or outdoors.

Another object of the invention is to provide water-resistant, shape-retaining fabric, ribbons, and decorative bows, whether printed or solid-colored, for use in connection with wreaths and flower arrangements, which can withstand the effects of prolonged refrigeration.

A further object of the invention is to provide moisture-resistant, drape-retaining fabric, ribbons and bows.

Still another object of the invention is to provide a method of making fabric, ribbons or bows that will hold their shape and drape after exposure to moisture or extremes of temperature, without the necessity for external retaining means such as pins, staples or adhesives.

A further object of the invention is to provide a coated fabric which is able to withstand multiple washings and has good “pull”, i.e., the ability to withstand so many pounds of pull before the coating separates from the fabric.

Another object of the invention is to provide fabric, ribbons or bows which have dimensional stability and durability.

Yet another object of the invention is to provide fabric, ribbons, and bows which will not separate, pull apart or droop after exposure to the elements, refrigeration, or immersion in water.

Other aspects, objects and advantages of this invention will be apparent to those skilled in the art from the following description.

Thus, in accordance with the present invention there is provided a shape-retaining, weather-resistant, and moisture-resistant printed or solid fabric, wherein said fabric is completely and uniformly coated with a polymeric material on its reverse surface, and heat is applied to said coating for a sufficient time and at a sufficient temperature to cure said polymeric material so that said polymeric material penetrates the interstices of said fabric and forms a permanent coating on the reverse side of said fabric. The polymeric material is selected from the group consisting of polyvinyl chloride, urethane, or a polyvinyl chloride-urethane blend. The most preferred polymeric material is polyvinyl chloride. It is contemplated that said treated fabric will be cut into ribbons and can be formed into bows. In accordance with another aspect of the invention, there is provided a method of making a weather-resistant, shape-retaining sheet of printed or solid fabric for outdoor use or for use with refrigerated flower arrangements, comprising the steps of:

(a) spreading a continuous layer of a polymeric material on the reverse side of said fabric;

(b) removing the excess of said polymeric material from said fabric;

(c) removing wrinkles from said fabric; and

(d) applying heat to said polymeric material for a sufficient time and at a sufficient temperature to cure said polymeric material so that said polymeric material penetrates the interstices of said fabric and forms a permanent, uniform, moisture-resistant coating on the reverse side of said fabric.

Alternatively, a lamination or bonding process may be employed to coat the reverse, side of the fabric or ribbon. This lamination or bonding process comprises applying a heat sealing coating of polymeric material to the reverse, non-printed side of the fabric, and applying heat, sound waves, vibration or radio frequency to effect sealing. In a preferred process, an adhesive is added to assist in the lamination process.

In accordance with yet another aspect of the invention, ribbons and decorative bows may be formed of the weather-resistant, shape-retaining fabric or ribbon of printed or solid fabric produced in accordance with the method disclosed herein. Such ribbons and decorative bows are made by performing various operations on said sheets or ribbons, such as by cutting, folding, sewing, stapling, gluing or otherwise retaining said ribbon or bow in a folded condition, in accordance with known bow-forming techniques to produced desired bow shapes.

Further features of the invention are described or will become evident in the following detailed description.

### DESCRIPTION OF THE DRAWINGS

For a more complete understanding of the present invention reference may be had to the following description of the preferred embodiments taken in connection with the following drawings, of which:

FIG. 1 is a front view of a bow formed from a weather-resistant, shape retaining ribbon made in accordance with the invention.

FIG. 2 is a back view showing the bow of FIG. 1.

FIG. 3 is a view of the bow of FIGS. 1 and 2 immersed in water.

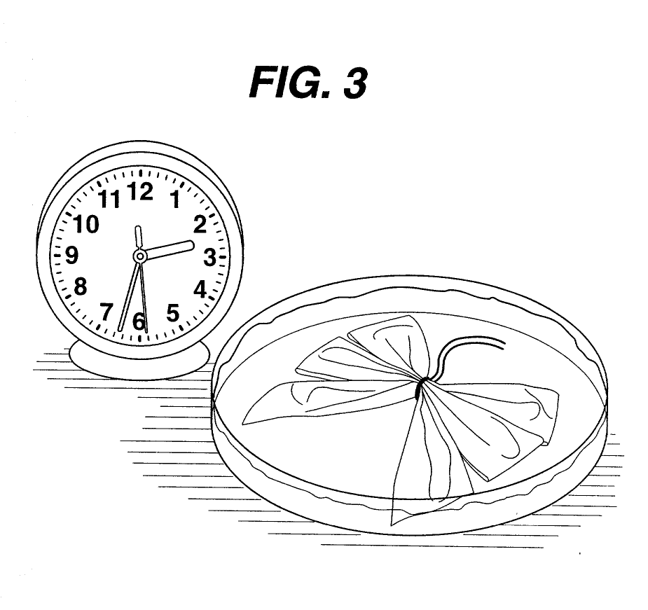

FIG. 4 is a front view of the bow of FIG. 1 following immersion in water for 18 hours.

FIG. 5 is a back view of the bow of FIG. 1 following immersion in water for 18 hours.

FIG. 6 is a front view of a prior art bow made of commercially available ribbon which is coated with acrylic on its reverse surface.

FIG. 7 is a back view of the prior art bow of FIG. 4.

FIG. 8 is a front view of the bow of FIG. 4 following immersion in water for two minutes.

### DETAILED DESCRIPTION OF THE PREFERRED EMBODIMENTS

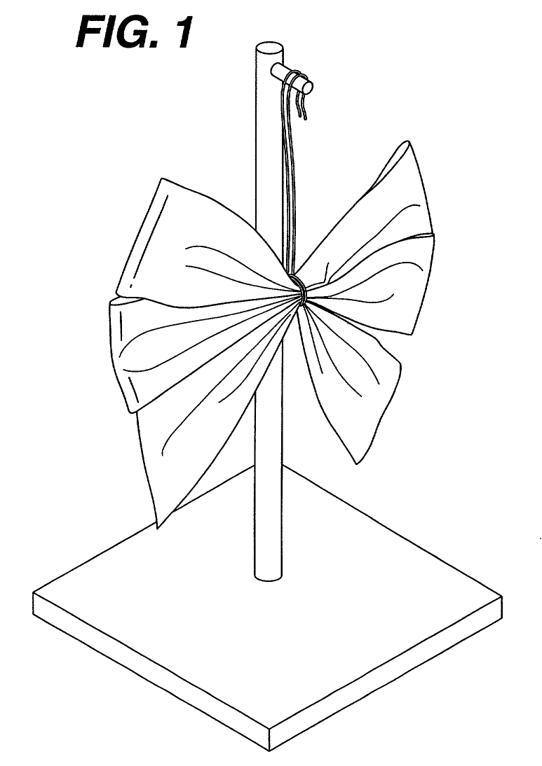

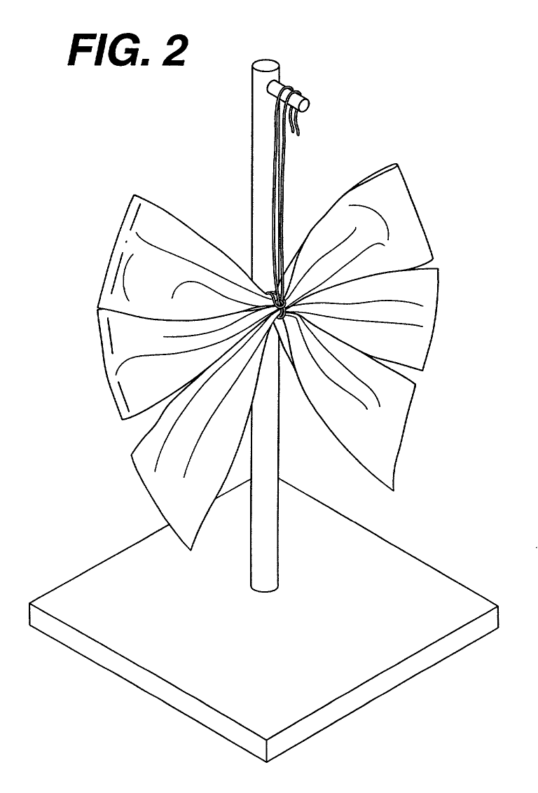

Referring to FIGS. 1 and 2, there is shown a decorative bow indicated generally at 10 made of a weather-resistant, shape-retaining ribbon 12 of printed fabric produced in accordance with the invention. The bow 10 is formed by manually tying a length of ribbon 12 in a bow shape, as is known in the art. The bow 10 is exemplary of one type of bow which may be formed, but other patterns and different size and shape bows which may be formed are within the scope of the invention.

The reverse side of the fabric is completely and uniformly coated with a polymeric material. The process of applying the polymeric material comprises spreading the polymeric material on the reverse side of the fabric, using a pump, rollers, brushes, or other spreading means, and heating said coating for a sufficient time and at a sufficient temperature to cure said polymeric material so that said polymeric material penetrates the interstices of said fabric and forms a permanent coating on the reverse side of said fabric. The fabric so treated is shape-retaining, weather resistant, and moisture-resistant.

It is preferred that the coating be applied only to one surface, preferably the reverse side, of the fabric, ribbon or bow. However, it is contemplated that the coating may be applied to both the front and reverse sides of the fabric, ribbon or bow, provided that the coating is applied very thinly to the front surface so as not to produce an undesirable sheen or “plastic” appearance to the fabric, ribbon or bow, which obscures the natural beauty of the fabric.

The polymeric material is selected from the group consisting of polyvinyl chloride, urethane, or a polyvinyl chloride-urethane blend in proportions ranging from 5% to 95% PVC to 95% to 5% urethane. The proportions of PVC to urethane depend on the application; the more urethane is added, the more durability and weather-resistance is imparted to the fabric. As this will be more expensive, there are cost constraints to consider. The preferred polymeric material is polyvinyl chloride.

In the case of lamination or bonding, the laminate film and the fabric are pulled over, under and/or through a series of rollers to laminate or bond the film to the reverse side of the fabric. The fabric is typically passed through one or more heated rolls to laminate the film to the reverse side of the fabric, and then passed through spreader rolls to remove wrinkles in the laminated fabric. Subsequent stations strip the excess film from the fabric, usually by means of a blade or knife assembly. It is of course possible to combine one or more of these processing steps in a single action.

In a preferred process, an adhesive is applied between the fabric and the laminate film. As the coated fabric travels through a series of rollers, including a nip roll, pressure and heat is applied to bond the two together. The objective is to obtain a coated fabric which is able to withstand repeated washings and has good “pull”, i.e., the ability to withstand so many pounds of pull before the laminate or coating separates from the fabric. Subsequently, the laminated fabric may be cut in continuous strips to form ribbons and coiled on spools or the like. Alternatively, the fabric or ribbons may be cut in predetermined patterns to form bows, and subsequently assembled. Additions and modifications may be made to the methods described above, without departing from the spirit and scope of the invention.

Accordingly, in another aspect of the invention, a decorative bow is formed from a printed or solid fabric, said fabric being shape-retaining, weather-resistant, and moisture-resistant, a protective film of polymeric material being laminated to the reverse side of said fabric, wherein said polymeric material is uniformly applied and penetrates the interstices of said fabric and forms a permanent coating on at least one side, preferably the reverse side, of said fabric.

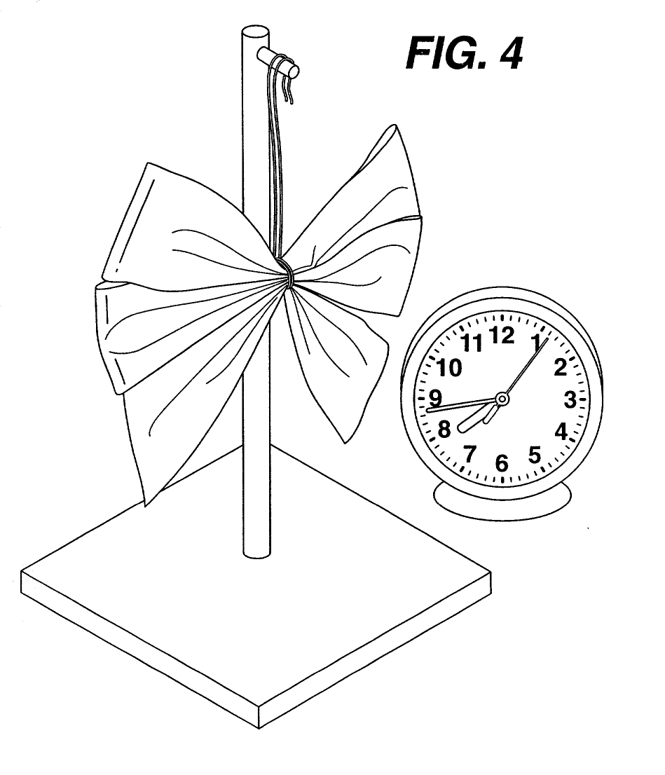

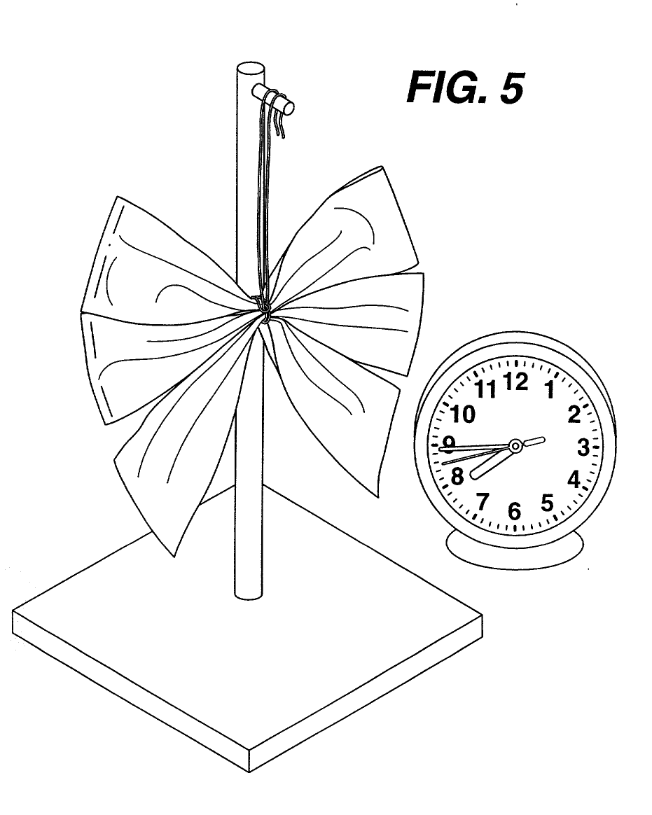

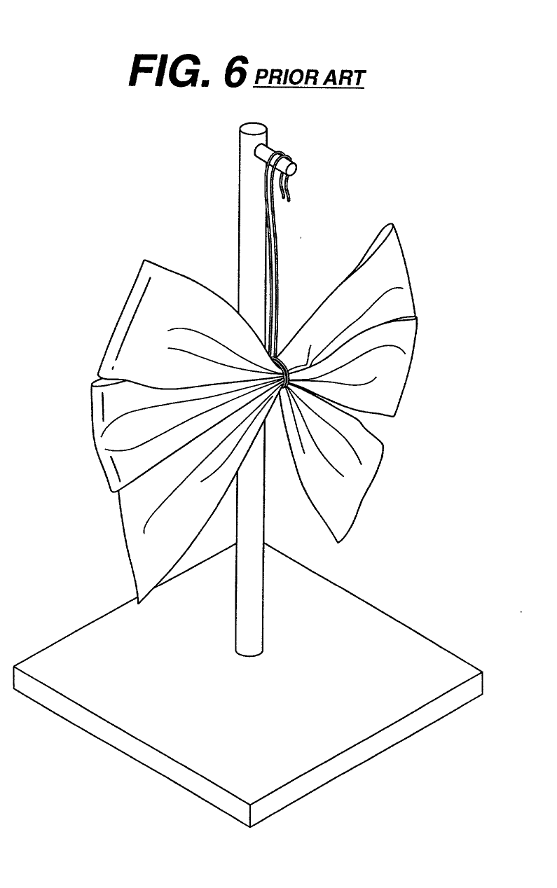

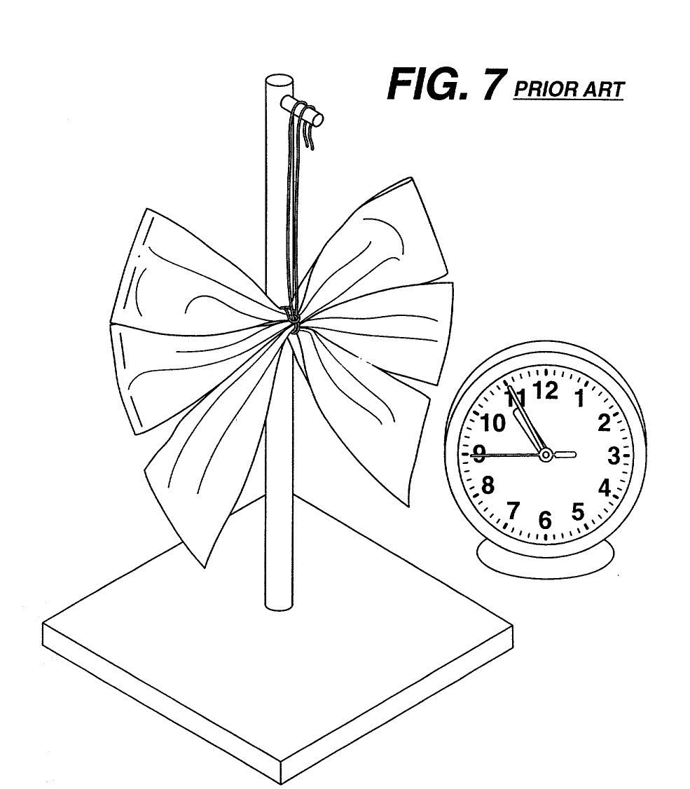

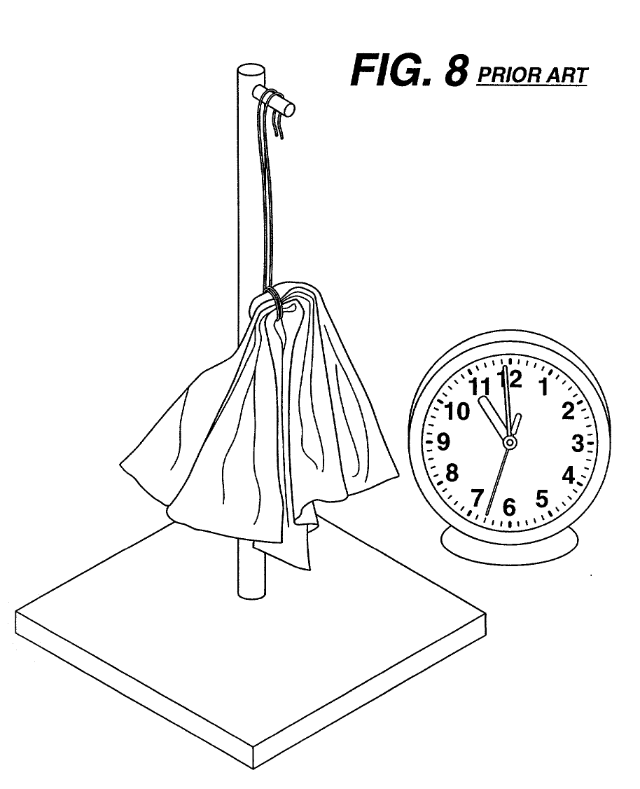

The polymeric coating lends dimensional stability to the fabric or ribbon, as well as provides durability in the form of weather-resistance, moisture-resistance, and the ability of the fabric, ribbon or bow of such fabric to retain its shape when moistened or refrigerated. Fabric, ribbons, and bows of the invention will not separate, pull apart or droop after exposure to the elements, refrigeration, or immersion in water. The polymeric coating thus provides support and reinforcement to the fabric, ribbon or bow. This is shown in FIGS. 4 and 5, where a bow formed of fabric or ribbon of the invention is seen to be intact, retaining its drape and shape after immersion in water for 18 hours. This is in contrast to the prior art bow shown in FIGS. 6-7, which is droopy and out of shape following immersion in water for two minutes. See FIG. 8. While FIG. 8 shows the bow out of shape after 2 minutes, the bow droops and loses its shape immediately upon contact with water.

The polyvinyl chloride is typically in powder form in a plasticizer which is a carrier with chemical characteristics, so that when heated it bonds with PVC. Thus, a slurry of polyvinyl chloride or a solution of polyvinyl chloride in a volatile solvent is contacted with the reverse of the fabric or ribbon to thereby allow the polyvinyl chloride to penetrate and permeate preferably only the reverse side of the fabric or ribbon. Thus, the polymeric material will flow into the fabric or ribbon structure to thereby coat the reverse side of the fabric or ribbon. When the polymeric material is allowed to solidify or when the solvent is allowed to evaporate, the fabric or ribbon is coated on the reverse, non-printed surface only. Heat is applied at temperature ranges of from 0° F. to 400° F. However, the temperature may be changed as required by the characteristics of the fabrics used.

The polymeric coating is a flexible, high strength material which is applied to the reverse side of the fabric or ribbon. The polymeric coating must exhibit a high degree of resistance to moisture and exposure to the elements, such as water, sunlight, and temperature fluctuations.

Any convenient method for applying the coating, such as by rolling, painting, spraying or troweling the coating onto the surface of the fabric may be utilized, as is known in the art.

As the coating of polymeric material is applied to one surface of the fabric or ribbon, the printed surface of the fabric is revealed. This is an advantageous feature as the printed surface of the fabric or ribbon does not have a “plastic” look, and the beauty of the fabric is exposed, adding to its decorative appeal.

The invention comprises a method for preparing a shape-sustaining, moisture and weather-resistant, flexible, printed fabric for covering or draping various items, for outdoor use or under extremes of temperature. Continuous, substantially flat, flexible, longitudinal ribbons may be made from said fabric in accordance with known methods, and coiled on a spool, paper strip, or the like. The manufacture of ribbons and bows is well known in the art and does not comprise a part of this invention. The fabric may be imprinted, embroidered or lacework, and used as shaped pieces or in ribbon or bow form. Alternatively, after the coating and heating steps and before passing the take-up roll, the fabric may be passed under an embossing roll, which is a metal roll with a pattern on it. This imparts a pattern to the fabric, such as the grain on artificial leather.

Alternatively, the flexible fabric may be decorated by printing, stitching, or embroidery and sold as is, as a finished product which requires no further processing, for example as tablecloths for outdoor use, or covers, or the like. Alternatively, the fabric may be further finished or sewn or otherwise fastened to form articles such as umbrellas.

The fabric comprises cloth selected from the group of materials consisting of natural or synthetic fibers or combinations thereof. More specifically, the fabric comprises cloth selected from the group consisting of nylon, polyester, rayon, metallics, polyester-cotton blend, and cotton. Most preferred is cotton.

The polymeric material may comprise one of any number of commercially available compounds, as long as the polymeric material does not result in decomposition of the fabric. More specifically, the polymeric material is selected from the group consisting of polyvinyl chloride, urethane, and a polyvinyl chloride-urethane blend, with polyvinyl chloride being the most preferred.

The fabric or ribbon is preferably imprinted or decorated with a pattern in ink in one or more colors and designs. The coating of polymeric material reinforces or stiffens the fabric or ribbon. The ribbon may optionally be made bendable by adding fibers or wire made of plastic, metal, or natural or synthetic fibrous compositions, to the outer periphery of the ribbon, as is known in the art.

The viscosity (thickness or pourability) of the coating depends on the desired application, such as the openness of the fabric weave. A fabric having a loose weave, such as a 42-62 thread-count fabric, requires use of a high viscosity coating, in the range of 40,000-50,000 cps. A fabric having a high thread-count, such as used in men's shirts, or most ribbons, requires use of a lower viscosity coating, with the consistency or pourability of water, in the range of 20,000-30,000 cps.

As the process of the invention contemplates coating preferably only the reverse side of the fabric or ribbon, and not the face of the fabric or ribbon, a higher viscosity coating is preferred, so the coating stays on the reverse side and does not “strike through” to the face of the fabric or ribbon. However, if it is desired to coat or penetrate both sides of the fabric or ribbon, then a greater quantity of coating is applied to the reverse side of the fabric or ribbon, so it “strikes through” to the face or front side. This makes it easier to subsequently coat the face of the fabric or ribbon.

The fabric to be coated has a thickness in the range of from about 1 mil to about 40 mils. The coating of polymeric material is applied in a thickness of from 0.05 mil to 40 mil., depending on the application. The amount of polymeric material applied to the fabric depends on the fabric thickness, the type of fabric, and the application. Typically, the amount of coating applied is in the range of from 0.5 oz. per square yard to 16 oz. per square yard of fabric, and preferably 3 to 4 oz. per square yard of fabric. It is possible to apply a thin layer of coating, for instance, 0.5 mil, and subsequently conduct multiple coating runs to add more layers of coating to build up the thickness of the coating.

The polymeric material is cured at temperatures in the range of 0° F. to 400° F., depending on the type of fabric and the nature of the polymeric material. The preferred temperature for curing PVC is in the range of preferably about 280° F. to 370° F., and preferably at about 320° F. The preferred curing temperature for urethane is the range of 300° F. to 370° F., preferably about 350° F. The temperature range is also dependent on the type of fabric. For acrylic fabrics, curing must take place at a lower temperature or the fabric will melt. For cotton fabric, a higher temperature may be used.

In a preferred embodiment, the coating is applied by means of a pump that takes the coating out of the barrel and transfers it into an overhead tray. The tray is equipped with a spigot which drops measurable amounts of the coating before the back-side of a knife, i.e., behind the knife. As the process runs, the fabric is pulled under the knife, and an even application of the coating is laid down on the fabric. As the coating is poured right before the back side of the knife, it is forced between the knife and fabric, and immediately smoothed, with the excess removed to the side.

The fabric to be coated may be in any shape and may be formed of a single layer of fabric or a plurality of layers of the same or different types of materials, such as lace layered on a solid cloth. Any thickness of the fabric may be used in accordance with the invention, as long as the fabric may be used to form bows, if desired. The preferred thickness of the fabric is from 1 mil. to 40 mil.

Any decorative pattern or surface ornamentation may be applied to fabric, including but not limited to colors, embossed patterns, printed designs, coatings, flocking or metallic finishes, as long as the fabric may be used to form bows, if desired.

The ribbon so formed is “shape-sustaining” or “shape-retaining”, meaning that the material may be shaped in the form of a bow or other shape and will hold that shape and not relax back into substantially the non-formed shape, without the necessity for external retaining means such as pinning, stapling or using an adhesive to force the fabric, ribbon or bow to maintain its shape or drape.

It will be understood that the embodiments described herein are merely exemplary and that a person skilled in the art may make many variations and modifications without departing from the spirit and scope of the invention. All such modifications and variations are intended to be included within the scope of the invention as described herein.

We claim:

1. A method of making moisture-resistant, shape-retaining fabric, comprising the steps of:
(a) contacting at least one surface of said fabric with a polymeric material; and
(b) curing said polymeric material so that said polymeric material penetrates the interstices of said fabric and forms a permanent coating on said at least one surface of said fabric.

2. The method of claim 1 further comprising after step (a) the step of removing excess polymeric material from said at least one surface of said fabric.

3. The method of claim 1 wherein said polymeric material is selected from the group consisting of polyvinyl chloride, urethane, or a polyvinyl chloride-urethane blend in proportions ranging from 5% to 95% polyvinyl chloride to 95% to 5% urethane.

4. The method of claim 1 wherein step (b) comprises applying heat to said polymeric material for a sufficient time and at a sufficient temperature to cure said polymeric material.

5. The method of claim 1 further comprising after step (b), the step of cutting said coated fabric in continuous strips to form ribbons.

6. The method of claim 5 further comprising the step of assembling said ribbons to form bows.

7. The method of claim 1 further comprising after step (b), the step of cutting said fabric in predetermined patterns and assembling said patterns to form bows.

8. A method of making a weather-resistant, shape-retaining fabric, comprising the steps of:
(a) applying a laminate film to at least one surface of said fabric; and
(b) passing said fabric through at least one heated roller to bond said film to said at least one surface of said fabric so that said film penetrates the interstices of said fabric and forms a laminated fabric.

9. The method of claim 8 further comprising after step (a), the step of removing excess film from said at least one surface of said fabric.

10. The method of claim 8 further comprising after step (b), the step of passing said laminated fabric through spreader rolls to remove wrinkles in said laminated fabric.

11. The method of claim 8 further comprising after step (a), the step of applying an adhesive between said fabric and said laminate film.

12. The method of claim 8 wherein said laminate film is selected from the group consisting of polyvinyl chloride, urethane, or a polyvinyl chloride-urethane blend in proportions ranging from 5% to 95% polyvinyl chloride to 95% to 5% urethane.

13. The method of claim 8 further comprising after step (b), the step of cutting said coated fabric in continuous strips to form ribbons.

14. The method of claim 8 further comprising the step of assembling said ribbons to form bows.

15. The method of claim 8 further comprising after step (b), the step of cutting said fabric in predetermined patterns and assembling said patterns to form bows.

16. The fabric made by the method of claim 1.

17. Ribbons made by the method of claim 1.

18. Bows made by the method of claim 1.

19. A fabric having at least one surface coated with a polymeric material which has been cured so that said polymeric material penetrates the interstices of said fabric and forms a permanent coating on said surface of said fabric.

20. The fabric of claim 19 wherein said polymeric material is selected from the group consisting of polyvinyl chloride, urethane, or a polyvinyl chloride-urethane blend in proportions ranging from 5% to 95% PVC to 95% to 5% urethane.

21. The fabric of claim 19 wherein said fabric comprises cloth selected from the group of materials consisting of natural or synthetic fibers or combinations thereof.

22. A decorative bow formed from shape-retaining, weather-resistant, and moisture-resistant fabric having a film of polymeric material laminated to at least one surface of said fabric such that said polymeric material has penetrated the interstices of said fabric.

23. Ribbon formed from shape-retaining, weather-resistant, and moisture-resistant fabric having a film of polymeric material laminated to at least one surface of said fabric such that said polymeric material has penetrated the interstices of said fabric.
